(19) United States
(12) Patent Application Publication
(10) Pub. No.: US 2025/0033974 A1
(43) Pub. Date: Jan. 30, 2025

(54) OPEN-STRUCTURED GRAPHENE FROM SELECT BIOMASS SOURCES AND METHODS OF MAKING AND USING THE SAME

(71) Applicants: Jonghyun Park, Rolla, MO (US); Tazdik Patwary Plateau, Rolla, MO (US)

(72) Inventors: Jonghyun Park, Rolla, MO (US); Tazdik Patwary Plateau, Rolla, MO (US)

(73) Assignee: The Curators of the University of Missouri, Columbia, MO (US)

(21) Appl. No.: 18/784,439

(22) Filed: Jul. 25, 2024

Related U.S. Application Data
(60) Provisional application No. 63/515,376, filed on Jul. 25, 2023.
(60) Provisional application No. 63/515,470, filed on Jul. 25, 2023.

(51) Int. Cl. C01B 32/19

(52) U.S. Cl. CPC C01B 32/19; C01B 2204/22; C01P 2004/03; C01P 2004/04; C01P 2006/40

(57) ABSTRACT

A unique open-structured graphene material is provided as well as methods of making and using the same. The open-structured graphene may be formed by carbonization of biomass, such as soybeans, followed by an exfoliation process to provide the graphene particles. Unlike pristine graphene, the open-structured graphene of the present technology has an irregular hierarchical pore structure and one or more layers with an undulating shape, which permits it to better facilitate the intercalation of certain doping particles and provides enhanced flexibility to maintain its structure in various end use application (e.g., batteries).

### CROSS-REFERENCE TO RELATED APPLICATIONS

This application claims the priority benefit under 35 U.S.C. § 119(e) of U.S. Provisional Patent Application Ser. No. 63/515,376, entitled “Open-Structured Graphene from Select Biomass Sources and Methods of Making and Using the Same,” and U.S. Provisional Patent Application Ser. No. 63/515,470, entitled “High-Efficiency, High-Yield Electrochemical Exfoliation Process,” each filed on Jul. 25, 2023, the entire disclosures of which are incorporated by reference herein.

### BACKGROUND

### Field

This technology relates to the field of making and using graphene and, in particular, to disordered open-structured graphene as well as methods for its production and use.

### Description of Related Art

Graphene exists in various forms, with the most commonly available form being ordered single-layer graphene, where carbon-carbon bonds are formed through strong sp² hybridization. However, single-layer graphene cannot be effectively utilized in different electrochemical applications, such as batteries. For instance, a lithium-ion battery requires an electrically conductive material capable of accommodating lithium ions within its structure. Pure, single-layer graphene, with its defect-free two-dimensional shape, cannot accommodate any particles, and therefore cannot be used in such applications.

Another type of graphene is multi-layered graphene, which can accommodate some interstitial particles. However, due to the stacked layers, there is a limitation on the size of intercalated particles that can be accommodated. Attempting to insert larger particles often results in detachment (e.g., separating) of the graphene layers, which destroys the graphene structure. Graphite can be used to address this issue; however, graphite also has an ordered structure with a fixed gap between the layers (approximately 3.35-3.38 Å). Additionally, the layers of graphite are held together by van der Waals bonds, which makes particle/ion insertion between the layers difficult.

Apart from ordered graphene and graphite, there are also reports of disordered crosslinked graphene in the literature. These structures are intentionally created to improve mechanical and electrical properties. However, those disordered graphene structures have limitations in accommodating large-sized particles, due to the crosslinking between layers and portions of layers. Therefore, there is a need for a material capable of accommodating large-sized doping particles within its structure, while also being able to sustain volume changes during electrochemical reactions without destroying the layered carbon structure. Further, the material should itself be highly conductive and capable of being produced with a simple, economical, and, advantageously, sustainable process.

### SUMMARY

In one aspect, the present technology concerns a method of making open-structured graphene, the method comprising: (a) processing a biomass feedstock comprising one or more of whole soybeans soybean fragments, coffee beans, coffee bean fragments, legume seeds, legume seed fragments, rice grains, or grain flour to provide disordered hard carbon; and (b) deconstructing at least a portion of the disordered hard carbon to provide open-structured graphene.

In one aspect, the present technology concerns a method of making open-structured graphene, the method comprising electrochemically processing disordered hard carbon to provide open-structured graphene having a hierarchical pore structure comprising at least two of micropores, mesopores, and macropores, as determined by transmission electron microscopy (TEM) and scanning transmission electron microscopy (STEM).

In one aspect, the present technology concerns an open-structured graphene having a hierarchical pore structure, wherein the hierarchical pore structure includes at least two of micropores, mesopores, and macropores, and wherein at least a portion of one or more layer of the graphene has an undulating shape.

In one aspect, the present technology concerns a method of using open-structured graphene having a hierarchical pore structure, the method comprising: impregnating at least a portion of the pores of the open-structured graphene with one or more doping particles.

In one aspect, the present technology concerns a method of using open-structured graphene having a hierarchical pore structure, the method comprising: applying an ink composition comprising the open-structured graphene to a surface to provide a printed image on at least a portion of the surface, wherein at least a portion of the applying includes atomizing the ink composition.

In one aspect, the present technology concerns an article or composition comprising open-structured graphene with a hierarchical pore structure.

### BRIEF DESCRIPTION OF THE DRAWINGS

Embodiments of the present invention are described herein with reference to the following drawing figures, wherein:

FIG. 1 is a schematic block flow diagram of the major steps or zones for producing an open-structured graphene from a feedstock comprising soybeans or other biomass materials according to embodiments of the present technology;

FIG. 2a provides Scanning Electron Microscope (SEM) images of a graphene material at magnifications of 15,000× (left) and 120,000× (right);

FIG. 2b provides SEM images of a graphite material at magnifications of 12,000× (left) and 120,000× (right);

FIG. 2c provides an SEM image of a disordered hard carbon material produced as described in Example 1 at magnifications of 15,000× (left) and 120,000× (right);

FIG. 3a provides a Scanning Transmission Electron Microscopy (STEM) image and a schematic model of the surface of the disordered hard carbon material produced as described in Example 1;

FIG. 3b provides STEM images of an open-structured graphene material produced as described in Example 1;

FIG. 4a is a graphical representation of the results of a particle size analysis the open-structured graphene product formed as described in Example 1;

FIG. 4b is a graph summarizing the effect of varying electrolyte concentration during exfoliation of graphite on the electrical conductivity of the resulting graphene as described in Example 2;

FIG. 4c is a graph summarizing the effect of varying exfoliation time of graphite on the electrical conductivity of the resulting graphene as described in Example 2; and

FIG. 5 is a graph summarizing of the intermolecular forces of intercalated graphite and open-structured graphene modeled as described in Example 3.

### DETAILED DESCRIPTION

The present technology pertains to a novel type of graphene derived from one or more biomass sources, as well as methods of making and using the open-structured graphene.

As used herein, the term “graphene” refers to an at least partially ordered carbonaceous material that includes 10 or fewer monoatomic layers. In some embodiments, graphene can have a single layer, or it may be multi-layered. When multi-layered, graphene may include between about 2 and about 10, between about 2 and about 8, or between about 3 and about 6 layers. In contrast, as used herein, the term “graphite” refers to a carbonaceous material having more than 10 monoatomic layers. In some cases, graphite can include more than about 15, more than about 20, or more than about 30 monoatomic layers. Typically, the bonding amongst carbon atoms within the layers of graphene and graphite is sp² hybridized, while the inter-layer bonding (between layers) of graphite can be sp³ hybridized.

The graphene produced according to embodiments of the present technology is referred to as “open-structured” graphene. As used herein, the term “open-structured” graphene refers to graphene having a disordered and hierarchical pore structure. A hierarchical pore structure refers to a pore structure comprising nanopores and, more specifically, having at least two of, or even all three of, micropores, mesopores, and macropores, as defined by IUPAC. In particular, as used herein, the term “micropore” refers to pores having a width of not more than about 2 nm, the term “mesopore” refers to pores having a width in the range of about 2 nm to about 50 nm, and the term “macropore” refers to pores having a width greater than about 50 nm. Additionally, the term “nanopore” in accordance with the IUPAC system, encompasses all three categories and refers to pores having a width of no more than about 100 nm.

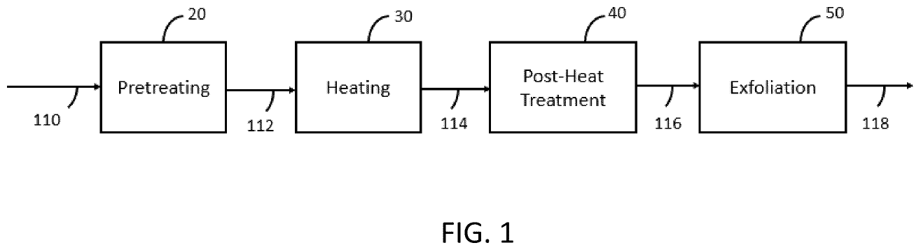

Turning now to FIG. 1, the major steps (or zones) of a method of making open-structured graphene according to embodiments of the present technology are provided. As generally shown in FIG. 1, a feedstock—usually a carbon-containing feedstock—can be introduced into the process via line 110. The carbon-containing feedstock can be any suitable type of feedstock and, in some embodiments, can comprise (or consist essentially of or consist of) at least one type of biomass material. In some embodiments, the feedstock in line 110 may comprise at least about 50%, at least about 75%, at least about 90%, or at least about 95% of one or more biomass materials, based on the total weight of the stream taken as 100%. In some cases, the feedstock in line 110 may comprise less than about 50%, less than about 25%, less than about 10%, or less than about 5% of non-biomass materials. Examples of suitable biomass materials can include various types of legumes, as well as other types of biomass such as coffee beans, rice, and/or various grain flours.

The feedstock in line 110 may be in the form of whole legumes, beans, and/or grains, and/or may include fragments of one or more of these components. For example, the feedstock in line 110 may comprise one or more of whole soybeans, soybean fragments, coffee beans, coffee bean fragments, legume seeds, legume seed fragments, rice grains, rice grain fragments, grain flour, or combinations thereof. In some embodiments, biomass materials certain proteins, such as trypsin, glycinin, and/or conglycinin, may be particularly suitable for preparing open-structured graphene as described herein. Soybeans are one type of biomass which may include one or more of these proteins. Although described herein primarily with respect to soybeans, it should be understood that the present technology may also apply to one or more of the other types of biomass listed above, individually or in combination with one or more other types listed above, with similar results.

Additionally, in some embodiments, the soybean material present in the feedstock in line 110 may not have been subjected to any type of processing step to physically and/or chemically decompose the soybean into its component parts. For example, the soybean (or other biomass material in the feedstock) may not have been processed to decompose it into (or remove) its component proteins, and it may also not have been processed to form a soybean oil. In fact, the biomass feedstock in line 110 (and, ultimately, the material introduced into the heating step or zone 30) may comprise not more than about 1%, not more than about 0.5%, not more than about 0.25%, or not more than about 0.1% by weight of oil and/or protein isolate from the biomass feedstock (including soybean protein isolate or soybean oil), based on the total weight of feedstock taken as 100%. In some cases, none of the soybean material (e.g., whole or fragmented soybeans) in the feedstock are in the form of soybean oil or soybean protein isolate.

According to some embodiments, the feedstock in line 110 may comprise whole soybeans and/or soybean fragments. For example, the feedstock can comprise at least about 40%, at least about 75%, or at least about 90% of whole soybeans and/or may comprise not more than about 50%, not more than about 25%, or not more than about 10% by weight of soybean fragments, based on the total weight of the feedstock taken as 100%. Or the amount of whole soybeans in the feedstock in line 110 can be in the range of from about 40% to about 100%, about 50% to about 99%, or about 80% to about 97% by weight, based on the total weight of the feedstock taken as 100%. Additionally, or in the alternative, the amount of soybean fragments in the feedstock in line 110 can be in the range of from greater than 0% to about 60%, about 1% to about 50%, or about 3% to about 20% by weight, based on the total weight of the feedstock taken as 100%. In some embodiments, the feedstock in line 110 can comprises at least about 75%, at least about 85%, at least about 90%, at least about 95%, or at least about 99% by weight of soybeans (whole and/or fragments), based on the total weight of the feedstock taken as 100%.

In some embodiments, the whole and/or fragmented soybeans (and/or other biomass material) in the feedstock in line 110 may comprise a plurality of solid pieces and may not be in the form of a liquid or in the form of a powder. Instead, the average particle size of the soybeans (or other biomass material) in line 110 being introduced into the pretreatment step or zone 20 can be in the range of from about 1 mm to about 20 mm, about 2 mm to about 15 mm, or about 5 mm to about 10 mm. As used herein, the average particle size refers to the average largest surface-to-surface dimension of the particles.

As shown in FIG. 1, the feedstock in line 110 may be introduced into a pretreatment zone or step 20. In pretreatment step or zone 20, the feedstock may be subjected to one or more processing steps to provide a more suitable feedstock for heating step or zone 30. Examples of suitable processing steps in the pretreatment zone 20 can include, but are not limited to, sorting by size, washing, separation to remove unwanted components, or combinations thereof. In some cases, a plurality of raw soybeans (or other biomass materials) can be washed, and the resulting washed particles can be subjected to a separation step to remove debris and other unwanted components. When used, the separation step may be carried out by, for example, gravity, filtration, and/or density separation.

In some cases, the pretreatment step or zone 20 does not include subjecting the raw soybeans (or other biomass feed) to any type of size reduction step (e.g., crushing and/or sieving) nor does it include any type of acid or base treatment. Instead, the processing steps performed in the pretreatment step or zone 20 may be carried out at ambient conditions (e.g., a temperature within about 5° C. of ambient and/or a pressure within about 5 psi of ambient) and/or at a neutral pH (e.g., a pH from about 6.5 to about 7.5).

The pretreated whole and/or fragmented soybeans (and/or other biomass material) leaving the pretreatment step or zone 20 in line 112 can then be introduced into a heating step or zone 30, as shown in FIG. 1. Although shown as two separate boxes in FIG. 1, it should be understood that these steps may be carried out in the same or different vessels or containers. Unlike conventional processes for producing graphene, the soybean (or other biomass) feedstock in line 112 may not be subjected to freeze-drying, hydrothermal processes, and/or extraction of oil from the soybean and/or soybean fragments. It may also not be subjected to any type of oxidative treatment or to any type of mechanical or chemical processes. In some embodiments, the soybeans (whole and/or fragments) may not be subjected to any type of acid or base treatment and the heating step itself may be carried out at a pH of from about 5.5 to about 7.5, about 5.75 to about 7.25, or about 6 to about 7.

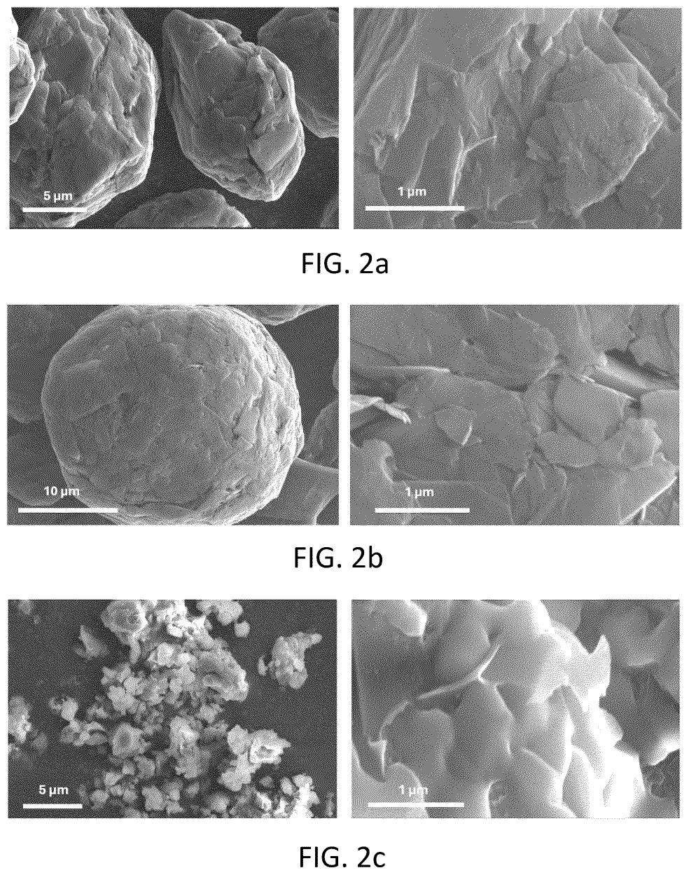

According to embodiments of the present technology, the soybeans (or other biomass material) can be heated in the heating step or zone 30 to temperatures sufficient to carbonize the material (e.g., proteins within the soybean or other biomass material) to thereby provide a disordered hard carbon. As used herein, the term “hard carbon” refers to a carbonaceous material having more than 10 layers that are strongly crosslinked and include highly immobilized small crystalline domains that cannot easily be reshuffled into well-aligned structures. The total number of layers in a disordered hard carbon material can be at least about 15, at least about 20, or at least about 25. Hard carbon has a disordered structure and may have a smaller particle size than most graphite or even other forms of graphene, as shown by comparison of scanning electron microscope (SEM) images of the graphene and graphite materials provided in FIGS. 2a and 2b, and the SEM image of hard carbon provided in FIG. 2c.

Turning back to FIG. 1, in some embodiments, the heating can comprise a multi-step heating process. In such cases, the soybean (or other biomass material) can first be heated to form a charred material, which can then be crushed and sieved. The resulting charred particles may then be combined with a base (e.g., potassium hydroxide) to form a mixture, which can then be heated to a temperature of about 700° C. or less. The heating can be performed in an inert atmosphere (e.g., nitrogen or argon) to prevent oxidation reactions.

In other embodiments, the heating may be a single-step heating process and may be carried out at higher temperatures, such as, for example, a temperature of at least about 700° C. In such embodiments, the soybeans (or other biomass material) may be heated to a temperature of at least about 700° C., at least about 750° C., about 800° C., about 850° C., about 900° C., about 950° C., or about 1000° C., or a temperature in the range of from about 700° C. to about 1100° C., about 750° C. to about 1050° C., or about 800° C. to about 1000° C. The heating can be carried out for a time period of at least about 15 minutes, at least about 20 minutes, at least about 30 minutes, at least about 45 minutes, at least about 50 minutes, or at least about 60 minutes, or a time period in the range of from about 15 minutes to about 120 minutes, about 30 minutes to about 90 minutes, or about 45 minutes to about 75 minutes.

The heating may be performed in any suitable environment. In some embodiments, the environment surrounding the soybean (or other biomass) during the heating can have an oxygen content of at least about 5%, at least about 7%, at least about 10%, at least about 12%, at least about 15%, at least about 17%, or at least about 20% by volume of oxygen, or it can comprise oxygen in an amount of about 5% to about 25% by volume, about 10% to about 23% by volume, or about 15% to about 22% by volume. Additionally, or in the alternative, the heating environment can comprise nitrogen in an amount of not more than about 95%, not more than about 90%, not more than about 85%, not more than about 80%, or not more than about 75% by volume. Nitrogen may be present in the heating environment in an amount in the range of from about 75% to about 95% by volume, about 77% to about 90% by volume, or about 78% to about 85% by volume. In some embodiments, the heating environment can comprise less than about 10%, less than about 8%, less than about 5%, less than about 2%, less than about 1%, or less than about 0.5% argon. Thus, the heating step according to embodiments of the present technology can be performed under air and does not need to be performed under an inert gas (e.g., pure nitrogen or argon) blanket.

Referring again to FIG. 1, the resulting disordered hard carbon produced by and removed from the heating step or zone 30 in line 114 may be introduced into an optional post-heating treatment step or zone 40. In some embodiments, at least a portion of the disordered hard carbon may be crushed to reduce its particle size and may optionally be combined with a solvent to form a hard carbon solution in the post-heating treatment step or zone 40. The resulting disordered hard carbon (as a solid or in a solution) can have an average particle size of at least about 1 micron, at least about 2 microns, or at least about 3 microns and/or not more than about 6 microns, not more than about 5 microns, or not more than about 4 microns, or it can be in the range of from about 1 to about 5 microns, or about 2 to about 4 microns. Unless otherwise noted herein, particle size was measured using a Dynamic Light Scattering Instrument (commercially available as Litesizer DLS 500 from Anton Parr) on a dispersion formed from 1 mg of particles in 10 ml of water mixed at 3500 rpm for 5 min.

As shown in FIG. 1, the post-heat treated hard carbon withdrawn from the treatment step or zone 40 in line 116 can then introduced into an exfoliation step or zone 50, wherein layers of the hard carbon are removed to provide graphene and, more specifically, open-structured graphene. In some embodiments, the exfoliation step or zone 50 can comprise mechanical exfoliation or thermal exfoliation, while, in other embodiments, it may comprise electrochemical exfoliation. In some cases, there are no intervening chemical processing steps or zones between the heating step or zone 30 and the exfoliation step or zone 50.

When the exfoliation step or zone 50 includes an electrochemical exfoliation step, the disordered hard carbon particles from the heating step or zone 30 (or the post-heat treatment step or zone 40) may be added to a solvent to form a hard carbon solution (if not already done in the post-heat treatment step or zone 40). In some embodiments, the solvent can comprise, consist essentially of, or consist of water optionally mixed with at least one electrolyte to form a homogeneous liquid. The electrolyte can be chosen from sulfuric acid, ammonium hydroxides, tetra-n-butyl ammonium sulfate, potassium sulfate, sodium hydroxide, and hydrogen peroxide, phosphoric acid, ammonium sulfate, sodium sulfate, potassium hydroxide, sodium bromide, sodium chloride, benzoic acid, sodium perchlorate, or combinations thereof. When used, the electrolyte may be present in the solution at a concentration of at least about 0.025 molar (M), at least about 0.05M, or at least about 0.10M and/or not more than about 0.5M, not more than about 0.4M, not more than about 0.25M, or not more than about 0.2M, or a concentration in the range of from about 0.025M to about 0.5M, about 0.05M to about 0.4M, or about 0.05M to about 0.25M.

The disordered hard carbon may be present in the hard carbon solution in an amount in the range of from about 0.1% to about 5% by weight, about 0.25% to about 3% by weight, or about 0.5% to about 2.5% by weight, based on the total weight of the hard carbon solution taken as 100%. The resulting hard carbon solution may include hard carbon particles, as well as the solvent, which, as discussed above, may include water and an, optionally, an electrolyte.

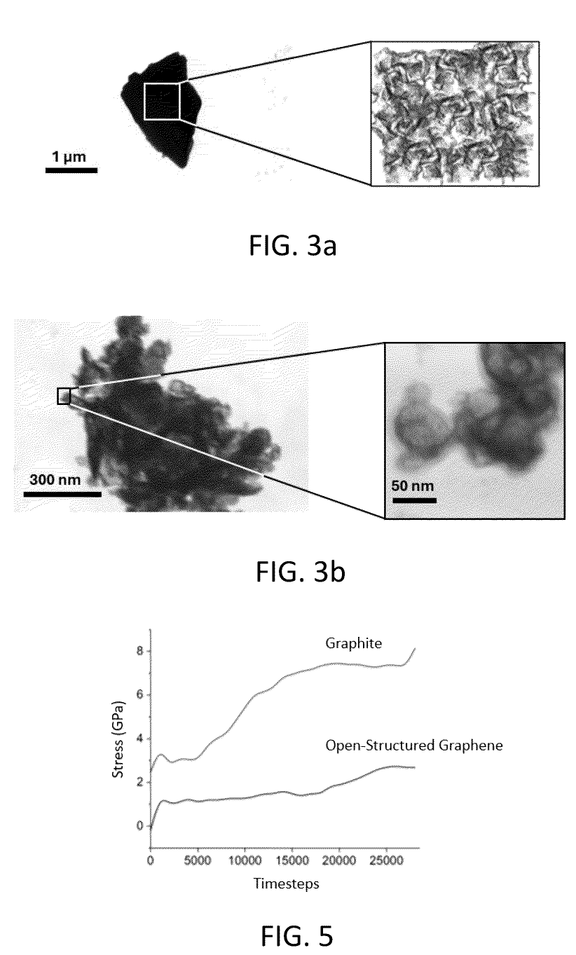

In the exfoliation step or zone 50, after the hard carbon solution is formed, a voltage may be applied to the solution thereby disassociating layers of the disordered hard carbon to produce open-structured graphene. In some embodiments, the application of voltage to the hard carbon in solution may result in breakage of the sp³ bonds (π bonds) between the hard carbon layers to provide the open-structured graphene, observable by, for example, comparison of STEM images of the open-structured graphene and hard carbon. The STEM images of open-structured graphene illustrate several very thin layers of carbon, while the hard carbon STEM images provide a larger, more particle-like structure. Examples of this are illustrated in FIGS. 3a (hard carbon) and 3b (open-structured graphene).

In some embodiments, the applied voltage can be at least about 1V, at least about 2V, at least about 3V, or at least about 5V and/or not more than about 25V, not more than about 20V, not more than about 15V, not more than about 12V, or not more than about 10V, or it can be in the range of from about 1V to about 25V, about 2V to about 20V, or about 5V to about 15V. The voltage may be applied during the electrochemical exfoliation for a time in the range of from about 1 hour to about 48 hours, about 8 hours to about 40 hours, or about 10 hours to about 30 hours.

Any suitable type of electrochemical exfoliation system may be used. In some embodiments, the electrochemical exfoliation system can be a two-electrode system comprising a primary electrode and a secondary electrode. In operation, the primary electrode is placed in the hard carbon solution such that the hard carbon particles contact the primary electrode. The secondary (or counter electrode) may comprise only a platinum electrode (e.g., a wire) and can be used to avoid side reactions within the system.

In other embodiments, multi-electrode systems (e.g., utilizing three or more and even up to several hundred electrodes) may be used. Further, the electrochemical exfoliation system may be operated in a batch or semi-batch or a continuous manner (e.g., closed-loop). Examples of electrochemical exfoliation systems suitable for use in various embodiments of the present technology are described in detail in the co-pending application entitled “High-Efficiency, High-Yield Electrochemical Exfoliation Process,” that claims priority to U.S. Provisional Patent Application Ser. No. 63/515,470, the entirety of the co-pending application being incorporated herein by reference.

Turning again to FIGS. 3a and 3b, various images of disordered hard carbon and open-structured graphene formed from a soybean feedstock as described herein are provided. The left portion of FIG. 3a provides a STEM image of a hard carbon particle and the right portion provides a magnified schematic image, obtained by 3D modeling software (Paint 3D commercially available from Microsoft), of the surface features of the hard carbon particle. FIG. 3b provides two STEM images, at different magnifications, of an open-structured graphene particle formed by electrochemically exfoliating a disordered hard carbon as shown in FIG. 3a and as described in detail in Example 1, below. As shown in FIG. 3b, the open-structured graphene material has a wavy (non-linear) structure that is not ordered or pristine.

As generally shown by comparing FIG. 3a with FIG. 3b, the open-structured graphene produced as described herein may have a smaller particle size than the disordered hard carbon used to form it. For example, in some embodiments, the disordered hard carbon can have an average particle size in the range of from about 1 microns to about 6 microns, about 2 microns to about 5 microns, or about 3 microns to about 4 microns, while the open-structured graphene may have an average particle size in the range of about 10 nm to about 2 microns, about 15 nm to about 1 micron, or about 25 nm to about 0.5 microns. Thus, the open-structured graphene may have an average particle size that is about 1.5 to about 20 times, about 2 to about 15 times, or about 5 to about 12 times smaller than the average particle size of the disordered hard carbon.

Additionally, the open-structured graphene formed as described herein can have a higher electrical conductivity than the disordered hard carbon from which it is formed. For example, in some embodiments, the open-structured graphene can have an electrical conductivity of at least about 20,000 (Siemens per meter) S/m, at least about 30,000 S/m, at least about 45,000 S/m, at least about 50,000 S/m, at least about 55,000 S/m, at least about 60,000 S/m, or at least about 65,000 S/m, or it can be in the range of from about 20,000 S/m to about 90,000 S/m, about 30,000 S/m to about 75,000 S/m, or about 45,000 S/m to about 65,000 S/m.

In some embodiments, the disordered hard carbon may have an electrical conductivity of less than about 1000 S/m, less than about 800 S/m, less than about 750 S/m, less than about 500 S/m, less than about 300 S/m, less than about 200 S/m, less than about 100 S/m, less than about 50 S/m, or less than about 40 S/m. The electrical conductivity of the materials described herein was measured using a four-point probe measurement technique with a digital source meter (Keithley 2400).

Thus, in some embodiments, the electrical conductivity of the open-structured graphene can be at least about 20%, at least about 25%, at least about 30%, at least about 35%, at least about 40%, at least about 45%, at least about 50%, at least about 55%, at least about 65%, at least about 70%, or at least about 75% higher than the electrical conductivity of the disordered hard carbon.

In some embodiments, the open-structured graphene may have a different chemical structure than the disordered hard carbon used to produce it. For example, hard carbon typically includes both sp²- and sp³-hybridized bonds, while open-structured graphene comprises predominantly sp²-hybridized bonds, and few or no sp³-hybridized bonds. Additionally, the open-structured graphene as described herein is not crosslinked.

As discussed previously, open-structured graphene has an at least partially disordered structure that differs from pristine graphene formed from graphite particles. The disordered nature of the open-structured graphene of the present technology may be characterized in a number of ways. For example, in some cases, at least a portion of the open-structured graphene has an uneven distribution or spacing of carbon atoms, as determined by STEM or SEM image or by Raman spectroscopy. Additionally, or in the alternative, at least a portion of the open-structured graphene may have an irregular shape and/or irregular size as compared to pristine graphene formed in a similar manner. Further, in some embodiments, at least a portion of the open-structured graphene may comprise one or more defects chosen from non-planar areas, crystalline defects, irregular open areas, and irregularities in the pore shapes and/or sizes, as determined by analysis of STEM images at a magnification of 120,000×. Additionally, or in the alternative, the open-structured graphene may also include one or more of the above defects as determined by analysis of TEM images at a magnification greater than 120,000×.

The open-structured graphene may comprise one or more monoatomic carbon layers each presenting at least one surface. In some embodiments, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95% of one or more of the surfaces may be non-planar (e.g., wavy or undulating). In some embodiments, all of the surfaces of the open-structured graphene may be at least partially non-planar (e.g., wavy or undulating).

According to some embodiments of the present technology, the open-structured graphene may comprise a multi-layered graphene. In such cases, the multi-layered open-structured graphene can include from about 2 to about 10 layers, from about 3 to about 8 layers, or from about 4 to about 6 layers. When multi-layered, the disordered open-structured graphene may include several layers not stacked upon one another and, as a result, two or more of the layers (optionally adjacent to one another) may not be parallel with each other. Such layers may be non-linear (or wavy or undulating) as determined by visual analysis of a STEM image at a magnification of at least 120,000×. This is in contrast to multi-layered pristine graphene, whose layers are all stacked upon each other, with each layer (adjacent or not) being within about 5° of being parallel with one another.

Accordingly, the disordered open-structured graphene may include adjacent layers that are unevenly (or inconsistently) spaced from one another, whereas pristine graphene would have even (or consistent) spacing between adjacent layers (e.g., an average spacing variation of less than about 5%, preferably less than about 3%, more preferably less than about 1%, and most preferably about 0%), usually being around 3 to 4 angstroms (Å). Due to the uneven spacing, portions of the open-structured graphene may have substantially larger spacing than would be expected in a pristine graphene and can, for example, be greater than about 5 Å, greater than about 10 Å, greater than about 25 Å, or greater than about 50 Å in at least a portion of the pore structure.

Pristine graphene formed by other methods typically comprises layers that are 2-dimensional (2D), meaning that such layers define a first and second dimension (usually length and width), but have a monoatomic third dimension (usually depth). Open-structured graphene according to embodiments of the present technology may comprise areas having a 2D layer structure but may also comprise portions having a 3-dimensional (3D), or non-monoatomic, layer structure. When present, the dimensions of the 3D structure of open-structured graphene are not necessarily oriented perpendicular to one another and may have any suitable orientation, thereby contributing to the overall disordered structure of the material.

In some embodiments when the open-structured graphene is a multi-layer graphene, at least a portion of the pores in its pore structure can be defined within a single layer of the graphene, while at least a portion of the pores in its pore structure can be defined between layers of the graphene. Such pores, whether within or in between layers, can have a variety of different sizes and orientations, as described in further detail below. As a result, the open-structured graphene of the present technology has a hierarchical pore structure, which means that it includes at least two types of nanopores chosen from micropores, mesopores, or macropores, as defined herein, and as determined by analysis of an STEM image of the sample. In contrast, pristine graphene has a more consistent pore size and would not include at least two (or all) of the above types of pores in a single sample. Unless otherwise noted herein, the pore sizes are determined using STEM imaging and a corresponding software (such as ImageJ) to determine the specific pore structure of the sample being analyzed.

In some embodiments, the open-structured graphene may include micropores in an amount of least about 5%, at least about 10%, at least about 15%, at least about 20%, at least about 25%, at least about 30%, at least about 35%, at least about 40%, at least about 45%, or at least about 50% and/or not more than about 90%, about 85%, about 80%, about 75%, about 70%, about 65%, about 60%, about 55%, about 50%, or about 45%, based on the total pore volume. In some embodiments the pore volume may comprise micropores in an amount of about 5% to about 90%, about 10% to about 65%, or about 15% to about 35%, based on the total pore volume taken as 100%.

Additionally, or in the alternative, the open-structured graphene as described herein can include mesopores in an amount of at least about 5%, at least about 10%, at least about 15%, at least about 20%, at least about 25%, at least about 30%, at least about 35%, at least about 40%, at least about 45%, or at least about 50% and/or not more than about 99%, not more than about 95%, not more than about 90%, not more than about 85%, not more than about 80%, not more than about 75%, not more than about 70%, not more than about 65%, not more than about 60%, not more than about 55%, not more than about 50%, or not more than about 45%, based on the total pore volume. In some embodiments, the pore volume may comprise mesopores in an amount of about 5% to about 90%, about 10% to about 85%, or about 25% to about 75%, based on the total pore volume taken as 100%.

Further, in some embodiments, the open-structured graphene can include macropores in an amount of at least about 5%, at least about 10%, at least about 15%, at least about 20%, at least about 25%, at least about 30%, at least about 35%, at least about 40%, at least about 45%, or at least about 50% and/or not more than about 90%, not more than about 85%, not more than about 80%, not more than about 75%, not more than about 70%, not more than about 65%, not more than about 60%, not more than about 55%, not more than about 50%, or not more than about 45%, based on the total pore volume. In some embodiments, the pore volume may comprise macropores in an amount of about 5% to about 90%, about 10% to about 75%, or about 15% to about 40%, based on the total pore volume taken as 100%. In all cases, the total pore volume including micropores, mesopores, and macropores, when present, total 100% of the pore volume of the open-structured graphene material. That is, in some embodiments, 100% of the total pore volume of the open-structured graphene material can comprise nanopores as defined herein.

In some embodiments, the average pore size of the open-structured graphene can be at least about 20 nm, at least about 25 nm, at least about 30 nm, at least about 35 nm, or at least about 50 nm and/or not more than about 100 nm, not more than about 90 nm, not more than about 75 nm, or not more than about 60 nm, or it can be in the range of from about 20 nm to about 100 nm, about 25 nm to about 90 nm, or about 25 nm to about 75 nm, as determined by SEM image analysis as described herein.

According to embodiments of the present technology, the unique disordered and irregular pore structure of open-structured graphene makes it particularly useful in doping applications wherein foreign (e.g., non-carbon) atoms are inserted into the open-structured graphene. Open-structured graphene as described herein comprises open spaces or sites capable of accommodating doping particles, thereby enhancing its functionality for various engineering applications. Examples of such applications include energy storage systems, renewable energy devices, photovoltaics, supercapacitors, fuel cells, flow batteries, and diverse biomedical applications. Other applications include nano-level biomedical devices, automotive equipment, aerospace, building materials, mobile devices, heat dissipation films, LED lightings, batteries, supercapacitors, advanced sensors, electronics, solar panels, DNA sequencing, and drug delivery applications.

In some embodiments, the open-structured graphene can have a pore structure oriented to accept doping particles having an average particle size of at least about 5 Å, at least about 10 Å, at least about 25 Å, at least about 50 Å, at least about 75 Å, or at least about 100 Å and/or not more than about 1000 Å, not more than about 750 Å, not more than about 500 Å, not more than about 250 Å, not more than about 100 Å, or not more than about 75 Å, or that have a particle size in the range of from about 5 Å to about 1000 Å, about 25 Å to about 750 Å, or about 50 Å to about 500 Å. Examples of suitable doping particles can include nitrogen (N), boron (B), silver (Ag), gold (Au), sulfur(S), iodine (I), lithium (Li), silicon(S), nickel (Ni), titanium (Ti), or combinations thereof.

In some embodiments, the open-structured graphene may be more suited for doping applications as compared to other forms of graphene and/or graphite because of the flexibility imparted by its disordered and irregular pore structure. This is particularly useful when, for example, the doping particles undergo expansion and contraction cycles during use. For example, lithium-doped carbon materials employed as anodes in lithium ion batteries tend to undergo significant expansion and contracting during charging and discharging cycles. Such movement within the structure of other types of graphene or graphite—particularly when repeated cyclically—results in damage to and breakage of the carbon structure. Thus, these materials are not well-suited for use in carbon-doping applications.

However, the unique pore structure of the open-structured graphene as described herein can facilitate expansion of the doping particle during use without causing damage to the carbon structure. Additionally, the open pore structure of the open-structured graphene of the present technology permits easier insertion of interstitial particles between layers, increasing both the efficiency and ease of producing and using doped open-structured graphene materials.

In some embodiments, the open-structured graphene can comprise at least one dopant (e.g., doping atom inserted into the carbon matrix) in an amount in the range of from about 1 mol % to about 40 mol %, about 2 mol % to about 30 mol %, or about 5 mol % to about 20 mol %, based on the total moles of the doped open-structured graphene taken as 100%. Levels of dopant in the carbon matrix can be measured using energy dispersive spectroscopy (EDS) with a Helios Hydra CX SEM commercially available from ThermoFisher Scientific.

When the doped open-structured graphene is subjected to conditions resulting in the expansion of one or more of the doping particles (e.g., expansion and contraction of the lithium ions in a lithium ion battery), the average size of at least one doping particle may increase by at least about 20%, at least about 30%, or at least about 40% from its original size. Additionally, or in the alternative, the average size of the doping particles can increase by less than about 100%, less than about 75%, or less than about 50%.

Even under such conditions, the open-structured graphene of the present technology can experience a total breakage of less than about 20%, less than about 10%, or less than about 5%, as measured by analysis of SEM or STEM images. Other forms of graphene or graphite materials would have total breakage rates significantly higher than 20%. The intermolecular stress generated within the open-structured graphene can be less than about 3, less than about 2.5, or less than about 2 gigapascals (GPa), even when exposed to the expansion conditions for a period of at least about 10 minutes, at least about 20 minutes, or at least about 45 minutes. In contrast, graphite may experience intermolecular stress of up to 8 GPa under the same conditions. Unless otherwise noted, intermolecular stress is measured using LAMMPS Molecular Dynamics Simulator available from Sandia National Laboratories.

According to other embodiments of the present technology, open-structured graphene may also be used in ink formulations, particularly those useful in additive manufacturing (e.g., 3D printing). Use of pristine graphene in such applications has not yet seen success on a broad scale, mainly due to problems with printer nozzle clogging caused by the size and shape of the particles of other forms of graphene. However, as discussed previously, the open-structured graphene formed according to embodiments of the present technology may have a generally smaller particle size and unique shape, which facilitates its use in a variety of ink compositions and printing applications.

In some embodiments, once the open-structured graphene has been formed as described above, it can optionally be washed with a wash solvent to remove any impurities before being used in an ink composition. Examples of suitable wash solvents include, but are not limited to, one or more chosen from dimethylformamide (DMF), a dilute acid such as sulfuric acid, phosphoric acid, hydrochloric acid, water, or combinations thereof. The open-structured graphene can be washed as many times as necessary to provide a purified open-structured graphene material comprising at least about 95%, at least about 97%, at least about 99%, or at least about 99.5% of open-structured graphene.

Next, the purified open-structured graphene can be combined with (or dispersed in) at least one solvent to form an ink composition. Any suitable solvent can be used and can, for example, comprise at least one alcohol chosen from C₁ to C₈ alcohols, and preferably C₁ to C₄ alcohols (e.g., ethanol, methanol, etc.). Other suitable solvents for use in ink compositions according to embodiments of the present technology include water and acetone. In some cases, the concentration of open-structured graphene particles in the ink compositions described herein may be in the range of from about 0.01 to about 1 molar (M), about 0.05 to about 0.5M, or about 0.075 to about 0.25M.

In some embodiments, the ink composition comprising open-structured graphene particles can be used in aerosol printing. By utilizing ultrasonic vibration from the transducer of the aerosol printing system, the atomization of the open-structured graphene particles can occur, and, by using a narrow nozzle and controlling the flow of sheath gas, the printing can be performed. This process can be applied to many types of substrates and can achieve very high-resolution printing. In some embodiments, when atomized in a printing nozzle, ink compositions including open-structured graphene particles as described herein plug less frequently than if an identical ink composition were formed but with pristine graphene particles, ceteris paribus.

### EXAMPLES

### Example 1—Property Analysis of Hard Carbon & Open-Structured Graphene

Open-structured graphene was produced by heating whole soybeans and soybean fragments at a temperature of 1000° C. for 1 hour in an air atmosphere to provide hard carbon. Scanning electron microscope (SEM) images of the hard carbon produced are provided in FIG. 2c at magnifications of 15,000× (left image) and 120,000× (right image).

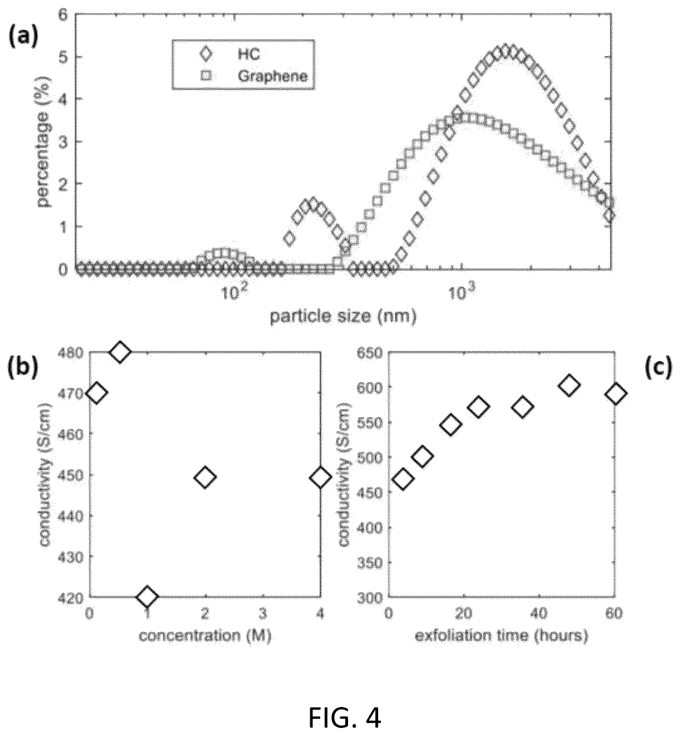

A sample of the hard carbon formed as above was dispersed in a 1M electrolyte solution and subjected to electrochemical exfoliation for 5 minutes at an applied voltage of 10V. Thereafter, a portion of the open-structured graphene material was recovered, and its particle size analyzed. The results of that analysis are provided in FIG. 4a. Note that some residual hard carbon material remained in the sample and its particle size distribution is also provided in FIG. 4a.

As shown in FIG. 4a, the exfoliation process reduces the size of the disordered hard carbon. However, the wider distribution curve indicates that the breaking that occurred during the exfoliation process was not uniform and resulted in particles having different sizes. Regardless, the average particle size of the exfoliated open-structured graphene was smaller than that of the hard carbon starting material.

### Example 2—Effect of Electrolyte Concentration and Exfoliation Time on Electroconductivity of Graphene

Samples of graphite (commercially available from Fisher Scientific) dissolved to form several electrolyte solutions using varying concentrations of ammonium hydroxide (commercially available from Fischer Scientific). Several electrochemical exfoliation trials were conducted with the different solutions. In some trials, the concentration of electrolytes in several of the solutions was varied from 0 to 4M and in other trials, the total exfoliation time was varied from 1 to 60 hours. Each trial was conducted under an applied voltage of 10V.

After conclusion of each exfoliation trial, the graphene formed was recovered and its electrical conductivity tested by taking four-point measurements using a digital source meter (Keithley 2400). The results are summarized graphically in FIG. 4b, where electrical conductivity is shown as a function of concentration, and FIG. 4c, where electrical conductivity is shown as a function of exfoliation time.

Further, as shown in FIGS. 4b and 4c, the electrical conductivity of the dispersion increased as the electrochemical exfoliation process was carried out, which is further indicative of successful production of graphene. Further, as shown in FIG. 4b, an electrolyte concentration of about 0.5M resulted in the most conductive graphene product, while higher electrolyte concentrations provided lower-conductivity graphene solutions (albeit still higher than the graphite feed). Also, as shown in FIG. 4c, an overall increase in electrical conductivity of the graphene particles resulted when exfoliation times greater than 24 hours were used, but after about 24 hours, the increase in conductivity seemed to level off.

### Example 3—Molecular Stress Modeling of Graphite & Open-Structured Graphene Intercalated with Lithium

Molecular dynamic simulations were performed using LAMMPS Molecular Dynamics Simulator (available from Sandia National Laboratories) to determine the intermolecular stress of open-structured graphene and graphite when each are intercalated with lithium particles. The results are provided in FIG. 5. As shown in FIG. 5, the open-structured graphene exhibited far lower levels of internal stress (e.g., less than about 3 GPa), while the graphite exhibit levels exceeding 7 GPa.

### DEFINITIONS

As used herein, the term “graphene” refers to an at least partially ordered carbonaceous material that includes 10 or less monoatomic layers. Graphene can have a single layer, or it can be multi-layered (e.g., 2 to 10 layers).

As used herein, the term “hard carbon” refers to a carbonaceous material having more than 10 layers and having a disordered structure. The layers of the hard carbon are strongly cross-linked and include highly immobilized small crystalline domains that cannot easily be reshuffled into well-aligned structures.

As used herein, the term “graphite” refers to a carbonaceous material having more than 10 layers. The bonding within the layer is generally sp² hybridized and between layers is generally sp³ hybridized.

As used herein, the term “hierarchical pore structure” refers to a pore structure having at least two of micropores, mesopores, and macropores.

As used herein, the term “open-structured graphene” refers to graphene with a hierarchical pore structure.

As used herein, the term “nanopore” refers to a pore having a width of less than 100 nanometers, as defined by the IUPAC system.

As used herein, the term “micropore” refers to a pore having a width of less than about 2 nm, as defined by the IUPAC system.

As used herein, the term “mesopore” refers to a pore having width of about 2 nm to about 50 nm, as defined by the IUPAC system.

As used herein, the term “macropore” refers to a pore having a width of greater than about 50 nm, as defined by the IUPAC system.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

As used herein, the phrase “at least a portion” includes at least a portion and up to and including the entire amount or time period.

What is claimed is:

1. A method of making open-structured graphene, the method comprising:
(a) processing a feedstock comprising at least one biomass component chosen from whole soybeans, soybean fragments, whole coffee beans, coffee bean fragments, whole legume seeds, legume seed fragments, whole rice grains, rice grain fragments, or grain flour to provide a disordered hard carbon; and
(b) deconstructing at least a portion of the disordered hard carbon to provide an open-structured graphene.

2. The method of claim 1, wherein the processing includes heating the biomass feedstock to a temperature greater than about 700° C. for at least about 15 minutes and/or heating the biomass feedstock in an environment comprising at least about 5% oxygen by volume.

3. The method of claim 1, wherein the biomass component comprises whole soybeans and/or soybean fragments.

4. The method of claim 1, wherein the heating is carried out in a single step.

5. The method of claim 1, wherein the processing includes heating the feedstock to a temperature in the range of from about 750° C. to about 1200° C. for a time period in the range of from about 20 minutes to about 90 minutes and wherein the heating is carried out in an environment comprising oxygen in an amount of from about 7% to about 24% by volume.

6. The method of claim 1, further comprising prior to the heating, pretreating raw soybeans to remove one or more undesired components and provide at least a portion of the biomass component, wherein the pretreating is carried out at ambient conditions and a neutral pH.

7. The method of claim 1, wherein the biomass component has an average particle size in the range of from about 1 mm to about 5 mm.

8. The method of claim 1, wherein the processing does not include freeze-drying, hydrothermal processes, extraction of oil and/or protein from the biomass component.

9. The method of claim 1, wherein no chemical processing is carried out between the processing and the deconstructing.

10. The method of claim 1, wherein the deconstructing comprises electrochemical exfoliation.

11. The method of claim 10, wherein the electrochemical exfoliation includes forming a solution of the disordered hard carbon in a solvent and applying a voltage to the hard carbon solution to provide the open-structured graphene, wherein the voltage applied is in the range of from about 1V to about 20V and the electrochemical exfoliation is carried out for a time in the range of from about 8 hours to about 30 hours.

12. The method of claim 1, wherein the disordered hard carbon has an electrical conductivity of less than about 200 S/m and the open-structured graphene has an electrical conductivity of at least about 20,000 S/m.

13. The method of claim 1, wherein the open-structured graphene comprises one or more monoatomic carbon layers having a surface and wherein at least about 75% of the surface is non-planar.

14. The method of claim 1, wherein the open-structured graphene comprises a multi-layered graphene.

15. The method of claim 1, wherein at least a portion of the open-structured graphene has an uneven distribution or uneven spacing of carbon atoms, as determined by analysis of an STEM image.

16. A method of making open-structured graphene, the method comprising electrochemically exfoliating a disordered hard carbon solution to provide open-structured graphene.

17. The method of claim 16, wherein at least a portion of the open-structured graphene includes one or more defects chosen from non-planar areas, crystalline defects, irregular open areas, irregularities in the pore shapes and/or sizes, and combinations thereof, as determined by analysis of STEM images.

18. The method of claim 16, wherein the open-structured graphene has an average pore size of about 20 to about 100 nm, as determined by STEM image analysis.

19. The method of claim 16, wherein the exfoliating is carried out with a two-electrode system and wherein said hard carbon solution comprises water and at least one electrolyte chosen from sulfuric acid, ammonium hydroxides, tetra-n-butyl ammonium sulfate, potassium sulfate, sodium hydroxide, and hydrogen peroxide, phosphoric acid, ammonium sulfate, sodium sulfate, potassium hydroxide, sodium bromide, sodium chloride, benzoic acid, sodium perchlorate, and combinations thereof.

20. An open-structured graphene having a hierarchical pore structure, wherein the hierarchical pore structure includes at least two of micropores, mesopores, and macropores, and wherein at least a portion of one or more layer of the graphene has an undulating shape.
